(19) United States
(12) Patent Application Publication
(10) Pub. No.: US 2007/0028152 A1
(43) Pub. Date: Feb. 1, 2007

(54) System and Method of Processing Received Line Traffic for PCI Express that Provides Line-Speed Processing, and Provides Substantial Gate-Count Savings

(76) Inventors: Kishore Kumar Mishra, Santa Clara, CA (US); Purna Chandra Mohanty, Santa Clara, CA (US)

Correspondence Address: INTELLECTUAL PROPERTY LAW GROUP LLP, 12 SOUTH FIRST STREET, SUITE 1205, SAN JOSE, CA, 95113, US

(21) Appl. No.: 11/461,444

(22) Filed: Jul. 31, 2006

Related U.S. Application Data
(60) Provisional application No. 60/595,739, filed on Aug. 1, 2005.

(51) Int. Cl. G06F 11/00

(52) U.S. Cl. 714/52

(57) ABSTRACT

A branch of CRC resources is configured to process back-to-back TLPs in a PCIe architecture. A state machine receives back-to-back TLPs and generates carrier signals, which it then routes to the branch of CRC resources. These signals are used to align the back-to-back TLPs such that a LCRC for each of the back-to-back TLPs is calculated by the branch of CRC resources at line speed. The system and method allow substantial gate-count savings to be realized, as the present invention minimizes the number of components necessary to achieve the desired results.

### CROSS-REFERENCE TO RELATED APPLICATIONS

This application claims the benefit of U.S. Provisional Application No. 60/595,739, filed on Aug. 1, 2005, which is hereby incorporated by reference.

### FIELD OF THE INVENTION

The invention relates generally to the PCI Express model of data transfer, and in particular to a system and method for processing received line traffic for PCI Express that guarantees line-speed processing, and further provides substantial gate-count savings.

### BACKGROUND OF THE INVENTION

Peripheral component interface (“PCI”) describes a protocol and architecture for transferring data, along a shared data bus, between a central processing unit and various I/O devices that exist at backend I/O channels. Since the PCI bus is a shared resource, the PCI devices must collectively arbitrate among themselves how use of the bus is to be divided up and distributed. This is feasible when only a few resources are sharing the PCI bus at any one time, but it becomes increasingly cumbersome as more resources are added to the bus. PCI's highly parallel shared-bus architecture limits its bus speed and scalability, which consequently limits the functionality that it may provide. More specifically, PCI's large-scale data parallelism increases noise along the bus and causes poor frequency scaling, and increases the cost of manufacturing PCI devices. Finally, PCI's simple, load-store, flat memory-based communications architecture is less dependable and robust than a routed, packet-based model.

PCI Express (“PCIe”) was developed to overcome the traditional limitations with the PCI model. In contrast to the older, parallel method of data transfer, the PCIe bus transfers data serially. The PCIe model also has a point-to-point bus topology, pursuant to which a shared switch replaces the shared bus of the PCI model, and each PCIe device is provided with its own individual bus through which to communicate with the shared switch. Thus, instead of all PCI devices sharing a common bus, all PCIe devices share a single switch, but are provided with an unshared communication bus (commonly referred to in a PCIe model as an unshared “link”). Consequently, each device in the system has direct and exclusive access to the switch, thus eliminating the collective arbitration process utilized by PCI devices in a traditional PCI model.

When two devices are communicating, the communicated data is broken up into discrete data packets known as transaction layer packets (“TLPs”), which are themselves comprised of multiple bytes of information. See FIG. 2. Payload bytes are used to transmit the parsed, communicated data that is carried in the packet. Sequence number bytes are used to track the order of packets. Successive packets are assigned sequence numbers pursuant to the sequence in which the packets are ordered. Header bytes contain the attributes of the packet such as address, length, etc. Finally, each TLP begins with a 1-byte start of packet (“STP”) symbol, and ends with a 1-byte end delimiter (“END”) symbol; PCIe compliant devices utilize this information to determine when a transaction is beginning and ending.

The PCIe model utilizes cyclic redundancy checks (“CRCs”) to detect errors in a transmitted TLP. A CRC, which functions as a checksum of transmitted bits in a TLP, is computed before the TLP is transmitted, and verified after its receipt. If the CRC has remained the same subsequent to the transaction, the system can be relatively assured that no changes occurred to the TLP during the transaction. However, if a data error does occur, the link layer hardware resends those TLPs that have been corrupted. Sequence numbers provide the receiving hardware with the means to properly reassemble data blocks even if they arrive out of order because they have been resent.

An end-to-end CRC (“ECRC”) is used to calculate the bits in the respective header and payload bytes. A link CRC (“LCRC”) is used to calculate the bits in the respective sequence number, header, payload and ECRC bytes. FIG. 2 illustrates which bytes are calculated in the respective ECRC and LCRC calculations. By using more than one CRC, the PCIe model is able to further limit the frequency of errors occurring in the TLPs.

When more than a single lane is used to transmit a TLP between two devices in a PCIe environment, the TLP can be sent in parallel. This method of data communication, known as byte stripping, increases data transfer throughput since more than a single lane is utilized. However, as the number of lanes that are simultaneously used to transmit a TLP increases (e.g., as is the case when 8 or more lanes are utilized), it becomes possible that a new TLP will start during the same clock period during which a previous TLP is ending. This makes it difficult to process the incoming TLP (i.e., calculate the LCRC value) at line-speed. Previous attempts to remedy this problem have resulted in solutions that greatly increase the system's gate-count, which of course causes the system to be overly complex and expensive. Therefore, there exists a need for a method of processing received line traffic in a multi-lane PCIe environment that guarantees line-speed processing, doesn't drop TLPs, and minimizes the resulting increase in the system's gate-count.

### SUMMARY OF THE INVENTION

In an embodiment, the present invention provides a system and method for processing back-to-back TLPs in a PCIe design utilizing a single branch of CRC resources in tandem with a FIFO module. The FIFO module temporarily stores an incoming TLP until the branch of CRC resources is finished processing a first TLP, and available to calculate the LCRC value of a second TLP. As long as the FIFO module has the requisite storage capacity, a plurality of back-to-back TLPs may be processed at line speed.

In another embodiment, the present invention provides a system and method for processing back-to-back TLPs in a PCIe design utilizing two branches of CRC resources that are each configured to calculate a LCRC for a TLP. Each successive back-to-back TLP is processed in the alternate branch. Such that the two branches are able to process back-to-back TLPs at line speed by dividing the requisite labor. This method of processing TLPs permits the system to process back-to-back TLPs at line speed when a new TLP begins in the same cycle that a current TLP ends. There is also less latency associated with the system, since the TLPs are not routed through a FIFO module.

In another embodiment, the present invention provides a system and method for processing back-to-back TLPs in a PCIe design utilizing a single branch of CRC resources that is capable of processing said back-to-back TLPs at line speed without the aid of a FIFO module. A state machine is configured to receive back-to-back TLPs and generate TLP_rest and TLP_end signals, which are routed to the branch of CRC resources. The TLP_rest and TLP_end signals are used to align the back-to-back TLPs such that a LCRC for each of the back-to-back TLPs is calculated by the branch of CRC resources at line speed.

In a preferred embodiment of the present invention, the branch of CRC resources is comprised of a 16-bit parallel CRC calculator, a 64-bit parallel CRC calculator, and a 32-bit parallel CRC calculator. The 16-bit parallel CRC calculator receives a hexadecimal 32-bit value and calculates a first CRC value. The result of the CRC calculation of the 16-bit parallel CRC calculator is routed to the 64-bit parallel CRC calculator. The result of the CRC calculation of the 64-bit parallel CRC calculator is routed to the 32-bit parallel CRC calculator, which generates the final LCRC value for the TLP.

The state machine sends the TLP_rest signal to the 16-bit parallel CRC calculator, the 32-bit parallel CRC calculators, and a Selection module. The state machine, using a split bus approach, also sends the TLP_end signal to the Selection module. The Selection module analyzes the processing of a first TLP such that it can determine when said processing is in its last cycle. When this occurs, the Selection module routes the TLP_end signal to the 64-bit parallel CRC calculator. When the processing of a first TLP is not in its last cycle, the Selection module routes the TLP_rest signal to the 64-bit parallel CRC calculator. Thus, the Selection module is able to control the CRC calculations of the branch of CRC resources such that the final LCRC value is contingent on the current state of the processing of a TLP.

These and other embodiments of the present invention are further made apparent, in the remainder of the present document, to those of ordinary skill in the art.

### BRIEF DESCRIPTION OF THE DRAWINGS

A better understanding of the invention will be obtained by considering the detailed description below, with reference to the following drawings. These drawings are not to be considered limitations in the scope of the invention, but are merely illustrative.

FIG. 1 illustrates a simplified PCIe architecture.

FIG. 2 illustrates the bytes of information that comprise a TLP, and the bytes of information that are calculated by the respective ECRC and LCRC calculations.

FIG. 3 illustrates a parallel CRC calculator.

FIG. 4 illustrates a single branch of CRC resources that calculates the LCRC values of back-to-back TLPs by utilizing a FIFO module to temporarily store the TLPs such that they may be processed at line speed, according to an embodiment of the present invention.

FIG. 5 illustrates a specific LCRC staging architecture utilizing a 16-bit, a 64-bit, and a 32-bit parallel calculator, according to an embodiment of the present invention.

FIG. 6 illustrates two branches of CRC resources that calculate the LCRC values for back-to-back TLPs at line speed, according to an embodiment of the present invention.

FIG. 7 illustrates a single branch of CRC resources that calculates the LCRC values of back-to-back TLPs by utilizing a state machine to align the TLPs such that they may be processed at line speed, according to an embodiment of the present invention.

FIG. 8 illustrates a method of aligning back-to-back TLPs, according to an embodiment of the present invention.

FIG. 9 illustrates a method of calculating a LCRC, according to an embodiment of the present invention.

FIG. 10 illustrates a method according to an embodiment of the present invention.

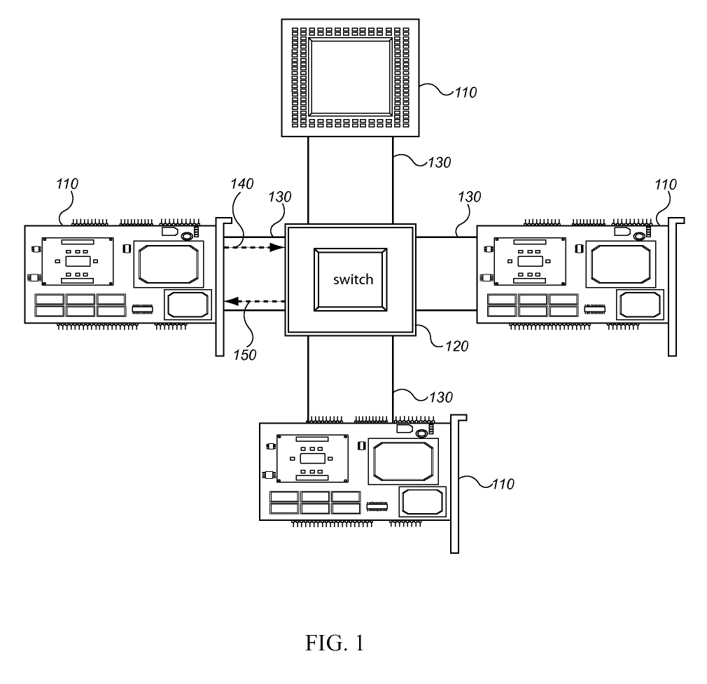

### DETAILED DESCRIPTION OF THE INVENTION

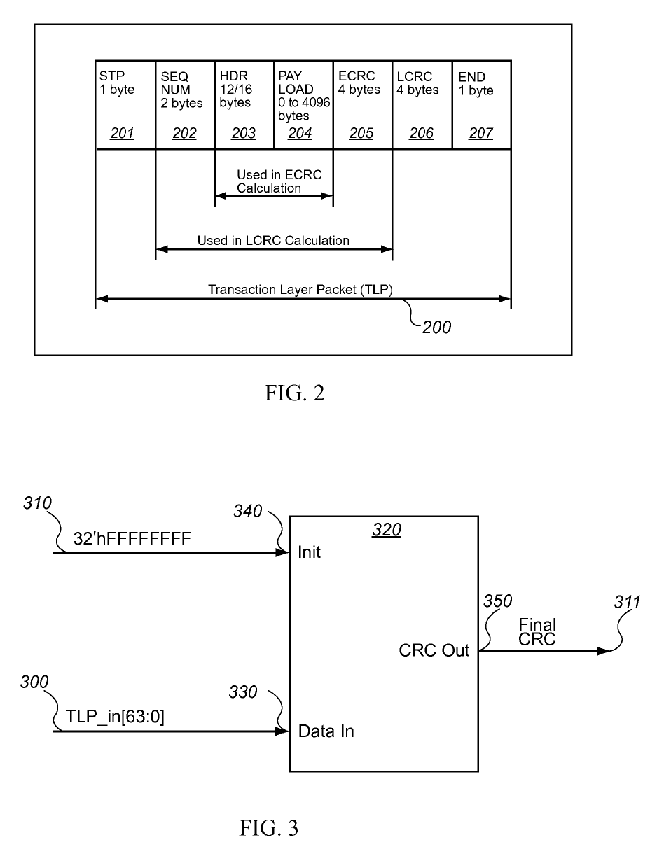

The invention relates to a system and method for processing back-to-back TLPs in a PCIe design. As shown in 1, a current PCIe architecture (or design) is illustrated. A PCIe architecture 100 typically comprises a plurality of PCIe compliant devices 110 that are linked together by a shared PCIe switch 120. The PCIe design further comprises a plurality of data buses 130 that are capable of transmitting bits of information in a serial configuration. The data buses route 140 data from the PCIe compliant devices to the shared PCIe switch. The shared switch routes 150 the TLPs and establishes point-to-point connections between any two communicating devices within the PCIe design. Communicated data in the PCIe design is broken up into TLPs 200. As shown in FIG. 2, a TLP 200 is comprised of a STP byte 201, which communicates to a receiving device that the TLP 200 is beginning. The TLP 200 is also comprised of an END byte 207, which communicates to a receiving device that the TLP 200 is ending. The TLP is further comprised of payload bytes 204 that are used to transmit the parsed, communicated data that is carried in the TLP 200. Two sequence number bytes 202 are used to track the order of the TLP 200 such that packets received out of order may be reordered. A plurality of header bytes 203 contain the attributes of the TLP 200, such as address, length, etc. Each TLP 200 is comprised of four ECRC bytes 205 and four LCRC bytes 206. The ECRC bytes 205 are used to calculate the bits in the respective header 203 and payload bytes 204. The LCRC bytes 206 are used to calculate the bits in the sequence number 202, header 203, payload 204 and ECRC bytes 205.

FIG. 3 illustrates a parallel CRC calculator 320, which is used to calculate a CRC value 311 for an incoming TLP 300. A parallel CRC calculator is comprised of a DATA IN port 330, an INIT port 340, and a CRC OUT port 350. An incoming TLP 300 is sent to the DATA IN port 330 of the parallel CRC calculator 320, and a hexadecimal value 310 is sent to the INIT port 340. The parallel CRC calculator 320 then calculates a CRC value 311 for the incoming TLP 300. Specifically, the parallel CRC calculator stores the incoming data in a register and performs a logic XOR function between the stored data and a selected polynomial value. The parallel CRC calculator shifts the data in the register to the left if an inputted value is equal to “0”. A data value is only changed if an inputted value is equal to “1”, since any bit that is XORed with “0” is equal to itself. Once determined, the calculated CRC value 311 is returned via the CRC OUT port 350.

As shown in FIG. 4, a system for processing back-to-back TLPs in a PCIe design is described, according to an embodiment of the present invention. The system comprises a branch of CRC resources 460 that is configured to calculate a LCRC 411 for an incoming TLP 400. The system further comprises a FIFO module 470 that is configured to receive, store, and retransmit an incoming TLP 400. An incoming TLP 400 is routed to the FIFO module 470, which temporarily stores the incoming TLP 400; this is accomplished by writing the incoming TLP 400 to the write port 471 of the FIFO module 470. When the branch of CRC resources 460 is available to process a TLP, the FIFO module 470 routes the incoming TLP 400 to the branch of CRC resources 460, where a LCRC 411 for the incoming TLP 400 is calculated. A hexadecimal 32-bit value 410 is sent to the branch of CRC resources 460 to initialize the CRC calculation. If back-to-back TLPs are received by the system, the FIFO module 470 stores the back-to-back TLPs, and routes them to the branch of CRC resources 460 in the same order in which they were received. However, the FIFO module 470 will not route an incoming TLP 400 to the branch of CRC resources 460 until the branch of CRC resources 460 has finished processing a prior TLP. In this way, as long as the FIFO module 470 has the requisite storage capacity, the back-to-back TLPs may be processed at line speed.

As is further shown in FIG. 4, the branch of CRC resources 460 may be comprised of a plurality of parallel CRC calculators 420. The FIFO module 470 routes each back-to-back TLP to each of the parallel CRC calculators 420. The INIT port 441 of a first parallel CRC calculator 421 receives a hexadecimal 32-bit value 410, which initializes the CRC calculation of the first parallel CRC calculator 421. The result of the CRC calculation of the first parallel CRC calculator 421 is routed from the CRC OUT port 451 of the first parallel CRC calculator 421 to the INIT port 442 of a second parallel CRC calculator 422. Thus, the result of the CRC calculation of a first parallel CRC calculator 421 is used to initialize a second parallel CRC calculator 422. In this manner, where a branch of CRC resources 460 is comprised of “N” parallel CRC calculators 420, where “N” is an integer value, the “N”th parallel CRC calculator 424 is initialized by the result of the CRC calculation of the “N−1”th parallel CRC calculator 423. The final LCRC value 411 is generated by the “N”th parallel CRC calculator 424, which outputs the final LCRC value 411 at its CRC OUT port 454.

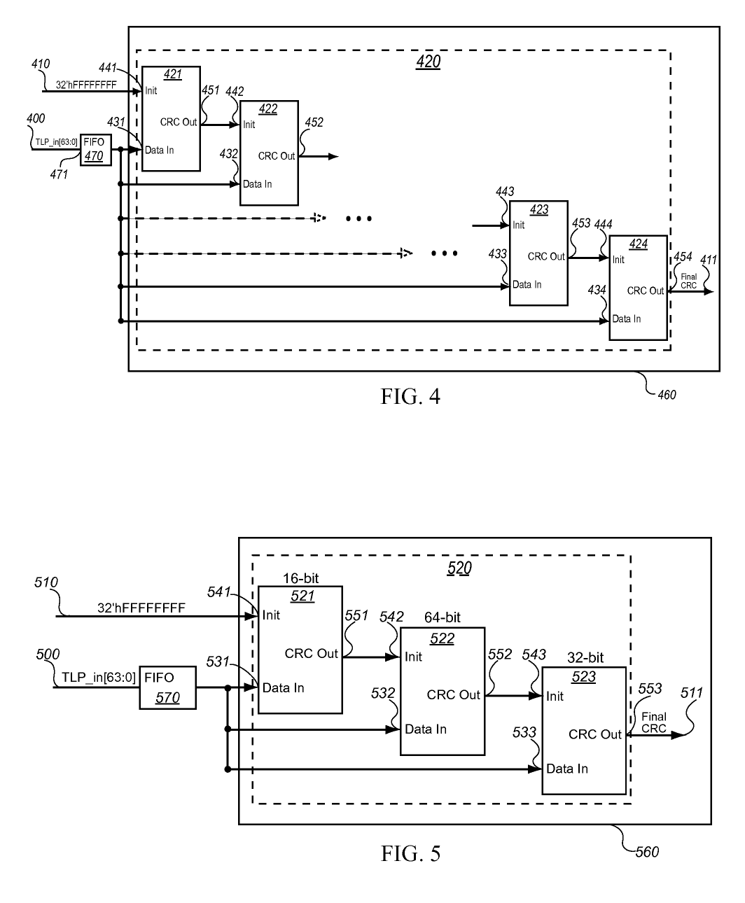

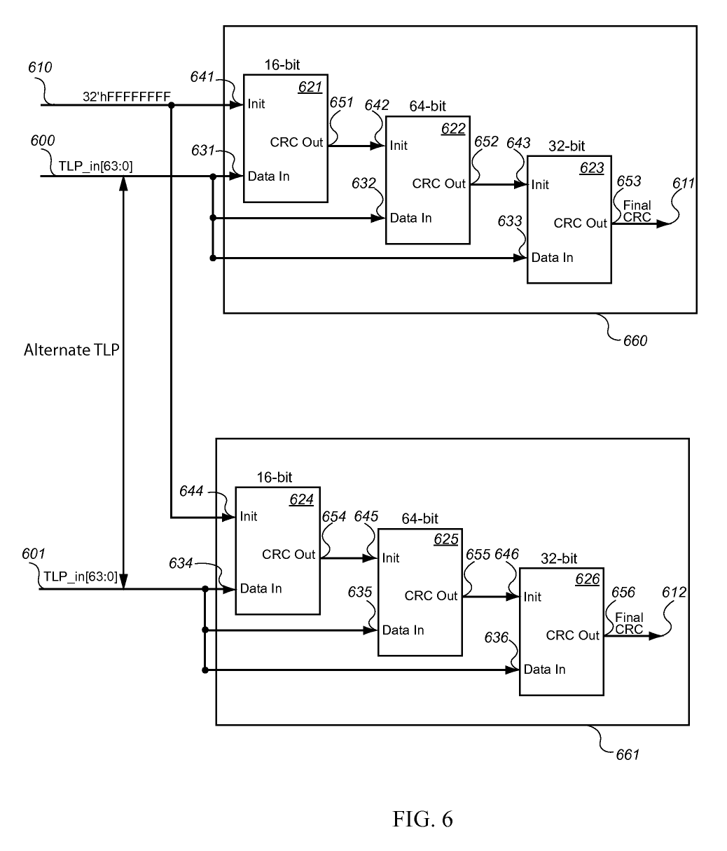

As shown in FIG. 5, the branch of CRC resources 560 may be comprised of a 16-bit parallel CRC calculator 521, a 64-bit parallel CRC calculator 522, and a 32-bit parallel CRC calculator 523. The FIFO module 570 routes each back-to-back TLP to each of the parallel CRC calculators 520. The INIT port 541 of the 16-bit parallel CRC calculator 521 receives a hexadecimal 32-bit value 510 that initializes the CRC calculation. The result of the CRC calculation of the 16-bit parallel CRC calculator 521 is routed from the CRC OUT port 551 of the 16-bit parallel CRC calculator 521 to the INIT 542 port of the 64-bit parallel CRC calculator 522. The result of the CRC calculation of the 64-bit parallel CRC calculator 522 is routed from the CRC OUT port 552 of the 64-bit parallel CRC calculator 522 to the INIT port 543 of the 32-bit parallel CRC calculator 523. The final LCRC value 511 is generated by the 32-bit parallel CRC calculator 523, which outputs the final CRC value at its CRC OUT port 553.

As shown in FIG. 6, a system for processing back-to-back TLPs in a PCIe design is described, according to an embodiment of the present invention. The system comprises two branches of CRC resources 660, 661 that are configured to calculate a LCRC for a TLP. One of the branches functions as a primary branch 660, while the other functions as a secondary branch 661. A first incoming TLP 600 is processed by the primary branch 660. A second incoming TLP 601 is processed by the secondary branch 661. This sequence is repeated such that each successive back-to-back TLP is processed in the alternate branch. The end result of the system is that the primary branch of CRC resources 661 produces a LCRC value 611 for a first incoming TLP 600, and the secondary branch of CRC resources produces a LCRC value 612 for a second incoming TLP 601. Therefore, the primary branch 660 and the secondary branch 661 work together to process the TLPs by dividing the requisite labor. This method of processing TLPs permits the system to process back-to-back TLPs at line speed when a new TLP begins in the same cycle that a current TLP ends. This solves the problem of processing TLPs at line speed as the system is capable of calculating the LCRCs for any number of back-to-back packets. In addition, there is less latency associated with the system as compared with the prior method, since the TLPs don't go through a FIFO module 570.

As is further shown in FIG. 6, each branch of CRC resources may be comprised of a plurality of parallel CRC calculators. Specifically, the primary branch of CRC resources 660 may be comprised of a 16-bit parallel CRC calculator 621, a 64-bit parallel CRC calculator 622, and a 32-bit parallel CRC calculator 623. Similarly, the secondary branch of CRC resources 661 may be comprised of a 16-bit parallel CRC calculator 624, a 64-bit parallel CRC calculator 625, and a 32-bit parallel CRC calculator 626.

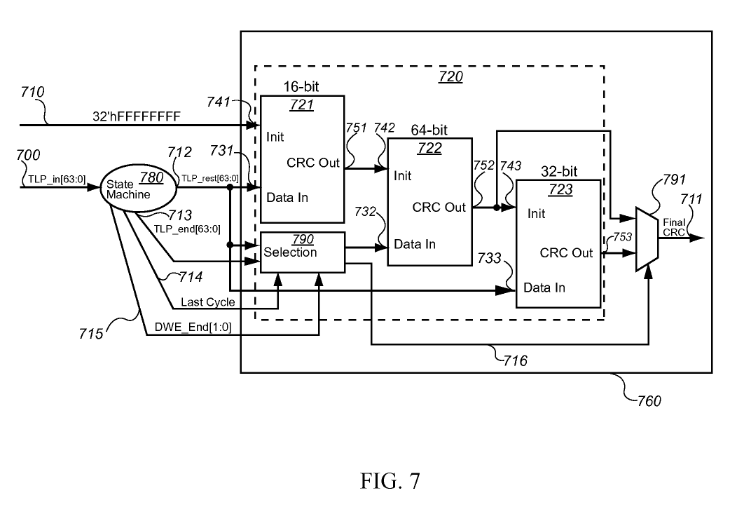

As shown in FIG. 7, a system for processing back-to-back TLPs in a PCIe design is described, according to an embodiment of the present invention. The system comprises a single branch of CRC resources 760 that is configured to calculate LCRC values for a plurality of back-to-back TLPs at line speed without the aid of a FIFO module 570. A state machine 780 is configured to receive back-to-back TLPs and generate TLP_rest 712 and TLP_end 713 signals. Specifically, when portions of two incoming TLPs overlap in the same clock cycle, the state machine 780 splits the input into two signals (TLP_rest 712 and TLP_end 713). A split data bus may be configured to route the TLP_rest 712 and TLP_end 713 signals to the branch of CRC resources 760. The system uses the TLP_rest 712 and TLP_end 713 signals to align the back-to-back TLPs such that they may be fed through the pipeline of CRC resources so that a LCRC for each of the back-to-back TLPs is calculated at line speed. Since only a single branch of CRC resources 760 is utilized, substantial gate-count savings may be realized.

As is further shown in FIG. 7, the branch of CRC resources 760 may be comprised of a plurality of parallel CRC calculators 720. Ideally, the branch of CRC resources is comprised of a 16-bit parallel CRC calculator 721, a 64-bit parallel CRC calculator 722, and a 32-bit parallel CRC calculator 723. FIG. 8 illustrates a method of calculating a LCRC using this configuration. The INIT port 741 of the 16-bit parallel CRC calculator 721 receives a hexadecimal 32-bit value 710 that initializes 801 the CRC calculation 811 of the 16-bit parallel CRC calculator 721. The result of the CRC calculation of the 16-bit parallel CRC calculator 721 is routed from the CRC OUT port 751 of the 16-bit parallel CRC calculator 721 to the INIT 742 port of the 64-bit parallel CRC calculator 722. The result of the 16-bit parallel CRC calculator 721 initializes 821 the CRC calculation 831 of the 64-bit parallel CRC calculator 722. The result of the CRC calculation 831 of the 64-bit parallel CRC calculator 722 is routed from the CRC OUT port 752 of the 64-bit parallel CRC calculator 722 to the INIT port 743 of the 32-bit parallel CRC calculator 723. The result of the 64-bit parallel CRC calculator 722 initializes 841 the CRC calculation 851 of the 32-bit parallel CRC calculator 723. The final LCRC value 711 is generated by the 32-bit parallel CRC calculator 723, which outputs the final LCRC value at its CRC OUT port 753.

The 16-bit parallel CRC calculator 721 may be configured such that it is utilized for only one clock cycle 811 during the processing of a first TLP. The 16-bit parallel CRC calculator 721 may be further configured such that it performs a CRC calculation during the beginning of the processing of a TLP. In a preferred embodiment, the 16-bit parallel CRC calculator 721 is used to perform a CRC calculation for the sequence number bytes 202.

The 64-bit parallel CRC calculator 722 may be configured such that it is utilized for three consecutive clock cycles 831, 832, 833 during the processing of a first TLP. The 32-bit parallel CRC calculator 723 may be configured such that it is utilized for only one clock cycle 851 during the processing of a first TLP. In a preferred embodiment, the final LCRC value 711 may be generated from either the 64-bit parallel CRC calculator 722 or the 32-bit parallel CRC calculator 723.

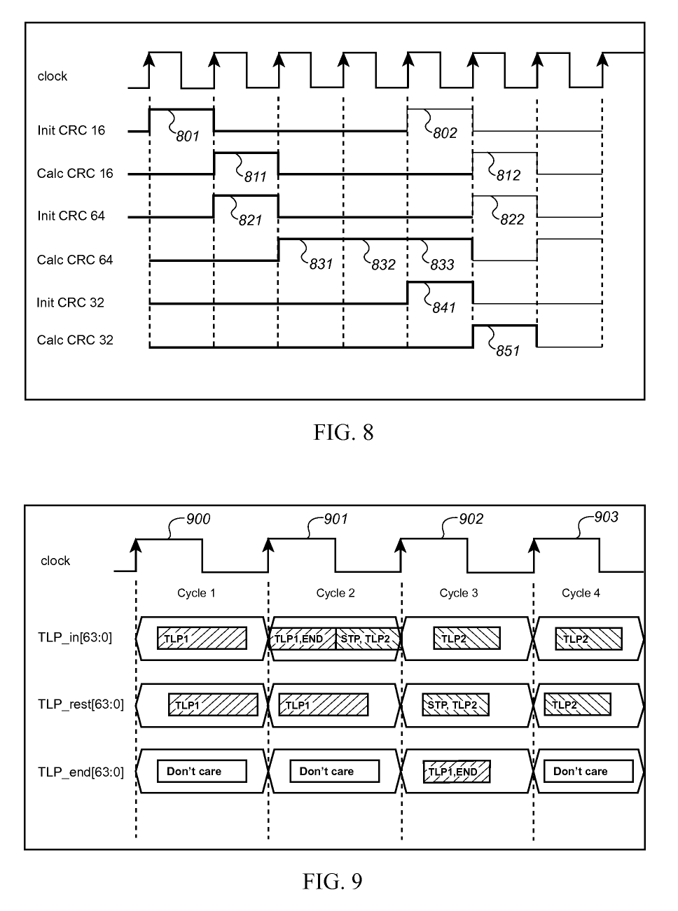

As shown in FIG. 9, the state machine 780 may be configured to align the END byte 207 of a first TLP with the STP byte 201 of a second TLP such that back-to-back TLPs may be processed in succession without any TLPs overlapping one another. If the incoming TLP 700 is a first TLP, the state machine 780 drives the first TLP to the branch of CRC resources 760 via the TLP_rest 712 signal during a first clock cycle 900. The TLP_rest 712 signal may be generated such that it is aligned with a STP byte 201 even if the STP byte 201 arrives on a fourth lane of a data bus.

As is further shown in FIG. 9, if during a second clock cycle 901 a second TLP begins during the same cycle that a first TLP ends, the state machine 780 drives both the TLP_rest 712 and TLP_end 713 signals during a third clock cycle 902. In this manner, the state machine 780 drives the TLP_rest 712 and TLP_end 713 signals at an exact clock cycle 902 in which a first TLP ends and a second TLP begins. The state machine 780 may also be configured to align and drive the TLP_rest 712 and TLP_end 713 signals such that the TLP_rest 712 and TLP_end 713 signals enter the branch of CRC resources 760 at specific cycles.

As is further shown in FIG. 9, if a second TLP begins during a same clock cycle 901 that the first TLP ends, the state machine 780 drives the first TLP to the branch of CRC resources 760 during the second clock cycle 901 via the TLP_rest 712 signal; the state machine 780 then drives the first TLP to the branch of CRC resources 760 during a third clock cycle 902 via the TLP_end 713 signal, and drives the second TLP to the branch of CRC resources during the third clock cycle 902 via the TLP_rest 712 signal. Thus, the state machine 780, by utilizing the previous cycle information and the current cycle information, aligns the END byte 207 of a first TLP with the STP byte 201 of a second TLP and drives the TLP_rest 712 and TLP_end 713 signals at an exact clock cycle in which a first TLP ends and a second TLP begins. This guarantees that a LCRC 206 for each TLP can be calculated at line speed.

As is further shown in FIG. 7, the system may further include a Selection module 790 that analyzes the processing state of a first TLP such that the processing of a second TLP does not overlap with the processing of the first TLP. The state machine 780 sends the TLP_rest 712 signal directly to the DATA IN port 731 of the 16-bit parallel CRC calculator 721 and to the DATA IN port 733 of the 32-bit parallel CRC calculator. The state machine may also be configured to send the TLP_rest 712 and TLP_end 713 signals to the Selection module 790. The Selection module 790 analyzes the processing of a first TLP 700 such that it can determine when said processing is in its last cycle. When the state machine 780 generates and routes a TLP_end 713 signal to the Selection module 790, the Selection module 790 routes the TLP_end 713 signal to the DATA IN port 732 of the 64-bit parallel CRC calculator 722. When the state machine 780 does not generate a TLP_end 713 signal, the Selection module 790 routes the TLP_rest 712 signal to the DATA IN port 732 of the 64-bit parallel CRC calculator 722. Thus, the Selection module 790 is able to control the CRC calculation of the 64-bit parallel CRC calculator 722, where said CRC calculation is used to initialize the 32-bit parallel CRC calculator 723, such that the end value of said CRC calculation is contingent on the current state of the processing of a TLP. In an embodiment, the TLP_rest 712 is routed to the 16-bit CRC calculator in the same cycle that the TLP_end 713 is routed to the 64-bit CRC calculator.

In another embodiment, the Selection module 790 may be a muxing agent (e.g., multiplexor) that selects which data to feed to the DATA IN port 732 of the 64-bit parallel CRC calculator 722 in response to a Last Cycle signal 714 that is routed from the state machine 780 to the Selection module 790. The state machine generates a Last Cycle signal 714 to signal the last cycle of the processing of a first TLP. When a Last Cycle signal 714 is not driven to the Selection module 790, the Selection module 790 routes the TLP_rest signal to the 64-bit parallel CRC resources. When the Selection module 790 receives a Last Cycle signal 714, it routes the TLP_end signal 713 to the 64-bit parallel CRC calculator 722. In this manner, the Selection module 790 directs the processing performed by the 64-bit parallel CRC calculator 722.

In another embodiment, the final LCRC value 711 may be generated from either the 64-bit parallel CRC calculator 722 or the 32-bit parallel CRC calculator 723. When the payload 204 of an incoming TLP 700 is a multiple of 32 bits, the branch of CRC resources 760 may finish processing the TLP during either the 64-bit 722 or 32-bit 723 CRC calculation stages. In a preferred embodiment, the final CRC calculations of both the 64-bit parallel CRC calculator 722 and the 32-bit parallel CRC calculator 723 are routed to a multiplexor 791. The state machine 780 generates a DWE_end signal 715 that indicates whether the processing of a TLP will end during the 64-bit stage 722 or else during the 32-bit stage 723. The DWE_end signal 715 is routed from the state machine 780 to the Selection module 790. The Selection module 790 generates and routes a control signal 716 to the multiplexor 791, and the multiplexor 791 outputs the final CRC value 711.

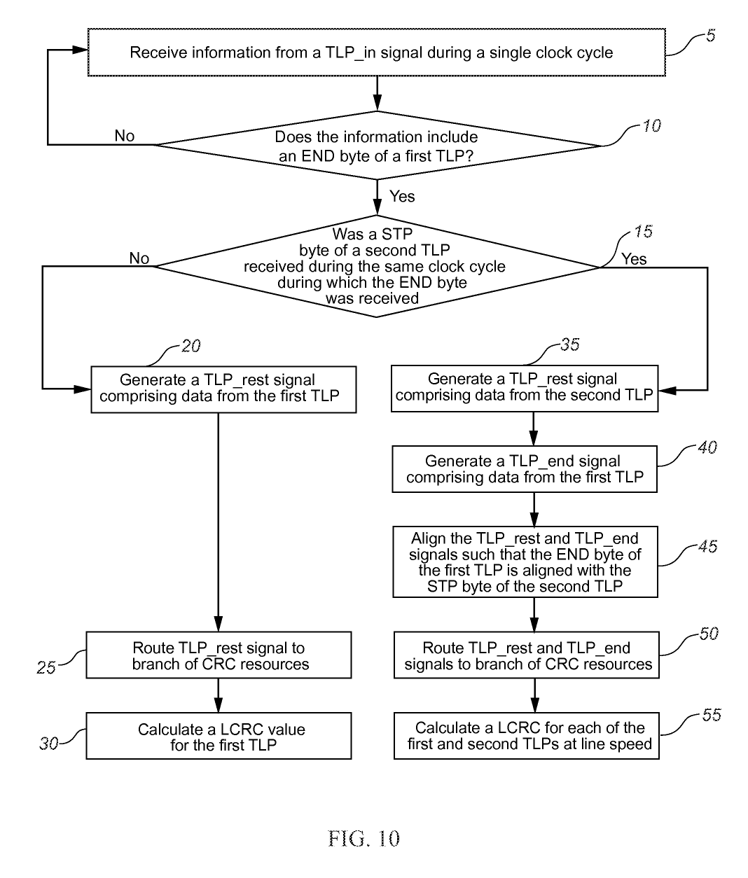

As shown in FIG. 10, a method for processing back-to-back TLPs in a PCIe design is described, according to an embodiment of the present invention. The method comprises receiving 5 information from a TLP_in signal during a single clock cycle, and determining 10 if the information includes an END byte 207 of a first TLP. The method further comprises determining 15 whether a STP byte 201 of a second TLP was received during the same clock cycle during which the END byte 207 was received. If such is not the case, a TLP_rest signal is generated 20 and routed 25 to a branch of CRC resources where a LCRC value for the first TLP is calculated 30.

As is further shown in FIG. 10, when the END byte 207 of a first TLP is received in the same clock cycle as the STP byte 201 of a second TLP is received, the method further comprises generating 35 a TLP_rest signal and generating 40 a TLP_end signal. These signals are aligned 45 such that the END byte of the first TLP is aligned with the STP byte of the second TLP. The method further comprises routing 50 the TLP_rest and TLP_end signals to a branch of CRC resources where a LCRC value is calculated 55, at line speed, for each of the first and second TLPs.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description, but rather is indicated by the appended claims. All changes that come within the meaning and range of equivalents within the claims are intended to be considered as being embraced within the spirit and scope of the claims.

What is claimed is:

1. A system for processing back-to-back TLPs, said system comprising:
a branch of CRC resources configured to calculate a LCRC for a TLP;
a state machine configured to generate a TLP_rest signal when a first TLP is received, and wherein the state machine is further configured to generate a TLP_end signal when a second TLP is received if the first TLP ends in the same cycle that the second TLP begins; and
a data bus configured to route the TLP_rest and TLP_end signals to the branch of CRC resources;
wherein the TLP_rest and TLP_end signals are used to align an END byte of a first TLP with a STP byte of a second TLP.

2. The system according to claim 1, wherein the data bus is split such that the TLP_rest and TLP_end signals are routed to different components within the branch of CRC resources.

3. The system according to claim 1, wherein the state machine aligns the TLP_rest and TLP_end signals such that the TLP_rest and TLP_end signals enter said branch of CRC resources at specific cycles.

4. The system according to claim 1, wherein the state machine drives the TLP_rest and TLP_end signals at an exact clock cycle in which a previous TLP ends and an incoming TLP begins.

5. The system according to claim 1, wherein the branch of CRC resources is comprised of a plurality of parallel CRC calculators.

6. The system according to claim 5, wherein the state machine routes TLP_rest and TLP_end signals to a selection module, and wherein the selection module routes the signals to a parallel CRC calculator.

7. The system according to claim 6, wherein the selection module is configured to route a TLP_end signal to a parallel CRC calculator when the selection module receives a TLP_end signal.

8. The system according to claim 6, wherein the selection module is configured to route a TLP_rest signal to a parallel CRC calculator when the selection module does not receive a TLP_end signal.

9. The system according to claim 6, wherein the parallel CRC calculator is a 64-bit parallel CRC calculator.

10. The system according to claim 1, wherein the branch of CRC resources is comprised of:
a 16-bit parallel CRC calculator;
a 64-bit parallel CRC calculator; and
a 32-bit parallel CRC calculator.

11. The system according to claim 10, wherein the 16-bit parallel CRC calculator performs a CRC calculation, and forwards the result of the CRC calculation to the 64-bit parallel CRC calculator.

12. The system according to claim 10, wherein the 16-bit parallel CRC calculator calculates a LCRC for sequence number bytes and forwards the LCRC for the sequence number bytes to the 64-bit parallel CRC calculator.

13. The system according to claim 10, wherein a result of the 64-bit parallel CRC calculator is forwarded to the 32-bit parallel CRC calculator, and where a final LCRC value is generated from one of either the 64-bit or 32-bit parallel CRC calculators.

14. The system according to claim 10, wherein a TLP_rest signal is routed to the 16-bit parallel CRC calculator, the 64-bit parallel CRC calculator, and the 32-bit parallel CRC calculator when a TLP_end signal is not generated.

15. The system according to claim 10, wherein a TLP_rest signal is routed to the 16-bit parallel CRC calculator and the 32-bit parallel CRC calculator, when a TLP_end signal is generated, and wherein the TLP_end signal is routed to the 64-bit parallel CRC calculator.

16. The system according to claim 15, wherein the TLP_rest signal enters the 16-bit parallel CRC calculator in the same cycle that the TLP_end signal enters the 64-bit parallel CRC calculator.

17. A method of processing back-to-back TLPs, said method comprising:
receiving information from first and second back-to-back TLPs;
aligning an END byte of the first TLP with a STP byte of the second TLP when the second TLP is beginning during the same clock cycle in which the first TLP is ending; and
calculating a LCRC for each of said back-to-back TLPs at line speed.

18. The method of claim 17, further comprising the step of generating a TLP_rest signal comprising data from the second TLP.

19. The method of claim 18, further comprising the step of generating a TLP_end signal comprising data from the first TLP.

20. The method of claim 19, further comprising the step of routing the first and second TLPs to a branch of CRC resources.
